(19) United States
(12) Patent Application Publication
(10) Pub. No.: US 2007/0151747 A1
(43) Pub. Date: Jul. 5, 2007

(54) ELECTRICAL CABLE

(76) Inventor: Jed Hacker, Brooklyn, NY (US)

Correspondence Address: Ilya Zborovsky, 6 Schoolhouse Way, Dix Hills, NY, 11746, US

(21) Appl. No.: 11/322,188

(22) Filed: Dec. 29, 2005

(51) Int. Cl. H01B 11/02

(52) U.S. Cl. 174/113 R

(57) ABSTRACT

An electrical cable has a first plurality of bundles each including a plurality of wires and connectable to a positive pole of a current source at one end, a second plurality of bundles each including a plurality of wires and connectable with a negative pole of the current source at one end, the bundles of the first plurality include bundles of different diameters and arranged so that the diameters of the bundles increase one after the other, while the second plurality of bundles includes bundles of different diameters and arranged so that the diameters of the bundles also increase one after the other, the wires in the bundles having different diameters so that the wires in a bundle with a greater diameter have a greater diameter and the wires in the bundle with a smaller diameter have a smaller diameter, and the wires of the bundles are twisted in opposite directions so that the wires in respective one of the bundles having a greater diameter is twisted in one direction, while the wires in one of the bundles which adjoins the bundle with a greater diameter and has a smaller diameter is twisted in an opposite direction.

### BACKGROUND OF THE INVENTION

The present invention relates to electrical cables for transmission of current.

Electrical cables are known in many constructions and configurations. Usually, electrical cables are composed of a plurality of bundles each including a plurality of wires or strands. Some of such electrical cables are disclosed in U.S. Pat. Nos. RE33750, 4,628,151; 4,654,476; 4,731,506; 4,777,324; 4,837,405; 4,873,393; 5,424,491; 5,519,173; 5,659,152; 6,096,977; 6,194,663; 6,323,427; 6,355,876; 6,452,094; 6,495,761; 6,495,763; 6,770,819; 6,794,570; 6,825,410; 6,958,444; and U.S. Published patent applications nos. 2005/0056454, U.S. 2005/0121222, U.S. 2005/0139378 A1, U.S. 2005/018913581, and U.S. 2005/0205288. It is believed that new cables can be further developed in order to improve their current transmission characteristics.

### SUMMARY OF THE INVENTION

Accordingly, it is an object of the present invention to provide an electrical cable which is a further improvement of the existing cables.

In keeping with these objects and with others, one feature of the present invention resides, briefly stated, in an electrical cable which includes a first plurality of bundles each including a plurality of wires and connectable to a positive pole of a current source at one end; a second plurality of bundles each including a plurality of wires and connectable with a negative pole of the current source at one end, said first plurality include bundles of different diameters and arranged so that the diameters of the bundles increase one after the other, while said second plurality of bundles includes bundles which of different diameters and arranged so that the diameters of the bundles also increase one after the other, said wires in said bundles having different diameters so that the wires in a bundle with a greater diameter have a greater diameter and the wires in the bundle with a smaller diameter have a smaller diameter and the wires of said bundles are twisted in opposite directions so that the wires in respective one of said bundles having a greater diameter is twisted in one direction, while the wires in one of said bundles which adjoins the bundle with a greater diameter and has a smaller diameter is twisted in an opposite direction.

When the electric cable is designed in accordance with the present invention, it has an increase current propagation speed, it is characterized by noise cancellation, and it possess a better quality for example for sound transmission.

In accordance with one embodiment of the present invention, the bundles in the first and second pluralities of bundles have increasing diameters in opposite directions, while in accordance with the other embodiment the bundles in the first and second pluralities of bundles have increasing diameters in the same direction.

In accordance with still a further feature of the present invention, a non-current conducting wire is located in a center of the electric cable between the first and second pluralities of bundles.

In accordance with still another feature of the present invention, the sheaths of the bundles are composed of different materials, so as not to form a single structure with negative effects.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a cross-section of a cable in accordance with one embodiment of an electrical cable in accordance with one embodiment of the present invention;

FIG. 2 is a view showing two neighboring bundles of the electrical cable in accordance with the present invention;

FIG. 3 is a view showing the electrical cable in accordance with another embodiment of the present invention; and

FIG. 4 is a view showing the electrical cable in accordance with still a further embodiment of the present invention.

### DESCRIPTION OF THE PREFERRED EMBODIMENTS

A cable in accordance with the present invention is identified as a whole with reference numeral 1. The cable 1 has a first plurality 2 of bundles having bundles 3 and connectable to one pole of current source, for example to a negative pole, and also a second plurality 4 of bundles having bundle 5 and connectable to another pole of the current source, for example to a positive pole. The opposite end of the cable and of all the bundles is connected to an electrical consumer.

In the cable 1 in accordance with the present invention the bundles 3 of the first plurality of bundles have an increasing diameter, as can be seen for example from bundles 3′, 3″, 3′″, 3′″.

Similarly, the bundles 5 of the second plurality of bundles 4 have an increasing diameter, as can be seen for example for bundles 5′, 5″, 5′″, and 5′″.

All of the bundles 3 and 5 in the pluralities of bundles 2 and 4 have a plurality of wires or strands which are identified correspondingly with reference numerals 6 and 7. In the cable in accordance with the present invention the number of wires in all bundles is substantially the same. However, the wires in a bundle with a greater diameter have a greater diameter, while the wires in a bundle with a smaller diameter have a smaller diameter correspondingly. In other words the diameters of the wires increase with the increase of the diameters of the bundles.

A core 8 can be arranged in a center of the cable 1 between the bundles 3 of the first plurality of bundles 2 and the bundles 5 of the second plurality of bundles 4, for orderly arranging the bundles in the cable. The core 8 can be formed can formed as a solid core or as a core having a central opening.

The bundles and the core extend in the same direction of elongation of the cable and are substantially parallel to one another.

The cable in accordance with the present invention is provided with a jacket, as well known in the art, and identified with reference numeral 9.

Each of the bundles can be covered with a sheath which is identified with reference numeral 10.

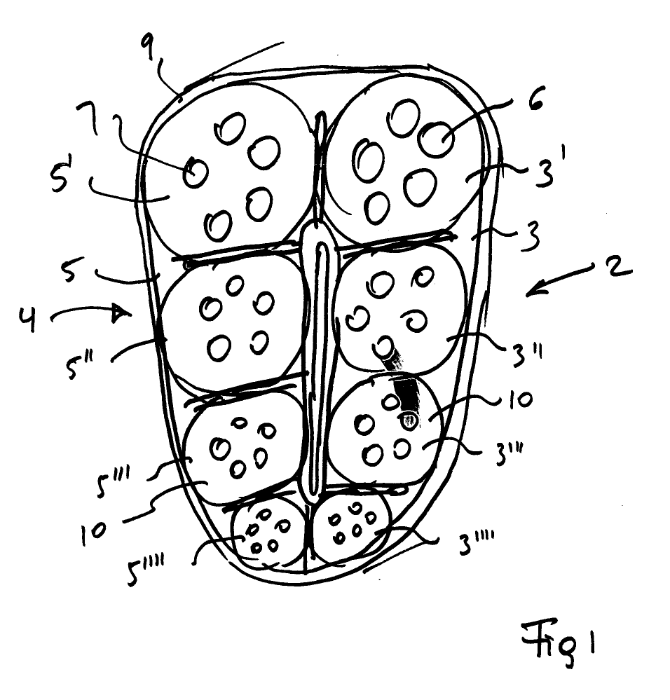

In one embodiment of the present invention shown in FIG. 1 the diameter of the bundles 3 in the plurality of the bundles 2 increases in one direction, for example in a counterclockwise direction, while the diameter of the bundles 5 in the second plurality of the bundles 4 increases in an opposite direction, for example in a clockwise direction.

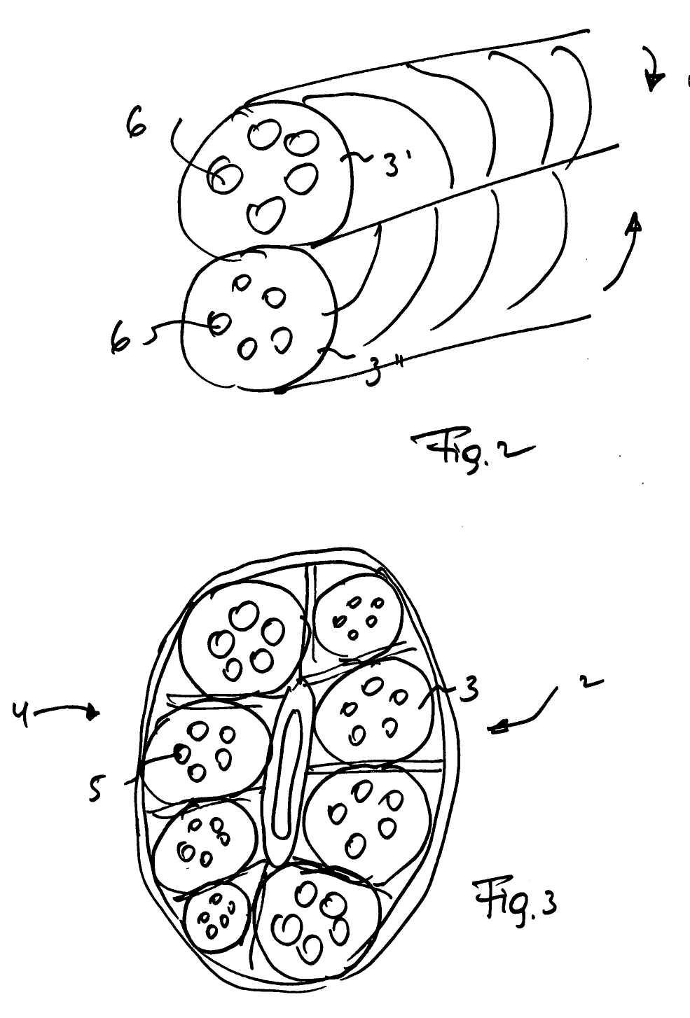

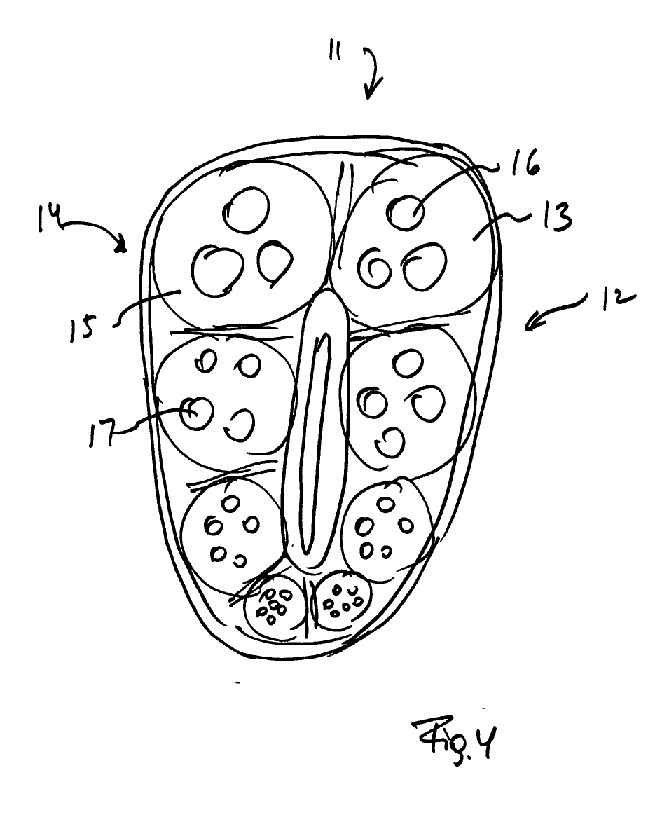

FIG. 3 shows a different embodiment of the present invention. Here the diameter of the bundles 3 in the plurality of bundles 2 increases in a first direction, for example in a clockwise direction, while the diameter of the bundles 5 in the plurality of bundles 4 also increases in the same, rclockwise direction. These two different embodiments provide corresponding advantages for different applications of the inventive cable.

In accordance with a further feature of the present invention, the wires 6 in the bundles 3 of the plurality of bundles 2, and the wires 7 in the bundles 5 of the plurality of bundles 4 are twisted, in particular in opposite direction. More particularly, in each of two neighboring bundles having different diameters the wires are twisted in two opposite directions, as shown with the arrows in FIGS. 1 and 3.

When considering in a direction of increasing of the diameter of the bundles, each preceding bundle with a smaller diameter and each subsequent bundle with a greater diameter have different directions of twisting, for example clockwise direction and counter clockwise direction, correspondingly.

In accordance with another embodiment shown in FIG. 4 the cable 11 has two sets 12 and 14 of bundles, which include bundles 13 and 15 with strands 16 and 17. The bundle in the sets of this embodiment have different diameters, the strands in the bundles have different diameters as well, and the numbers of the strands in the bundles are also different.

In accordance with the present invention it is further proposed to make sheaths on the bundles of different materials, so that two neighboring bundles have sheaths of different materials, for example of polyethylene and TEFLON. Thus, the sheath of a first bundle of one diameter can be composed of one material, and the sheath of an adjacent bundle of a different diameter is composed of a different material. This prevents formation of a single-material uninterrupted sheath structure, which conventionally affects the transmission.

Instead or in addition to it, a separating element 18 can be provided between the bundles and composed of a different material than the sheaths of the bundles and the jacket. The separating element 18 can be a part of the central core, and even made of one piece with it.

Also, the jacket can be composed of a material which is different that the material of the sheaths of the bundles, for example of polypropylene. It is also possible to use all above features simultaneously, namely the sheaths of the bundles of different materials, the jacket of a different material than the sheaths, and the separating element of a different material.

The different materials used for the jacket, the sheaths, the separating element can be polyethylene, polypropylene, kapton, teflon, nylon, neoprene, etc.

In general, when the cable is designed in accordance with the present invention, the speed of current transmission is increased and the quality of the current transmission is improved.

It will be understood that each of the elements described above, or two or more together, may also find a useful application in other types of constructions differing from the types described above.

While the invention has been illustrated and described as embodied in an electrical cable, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An electrical cable, comprising a first plurality of bundles each including a plurality of wires and connectable to a positive pole of a current source at one end; a second plurality of bundles each including a plurality of wires and connectable with a negative pole of the current source at one end; said bundles of said first plurality include bundles of different diameters and arranged so that the diameters of the bundles increase in one after the other, while said second plurality of bundles including bundles of different diameters and arranged so that the diameters of the bundles also increase one after the other, said wires in each of said first and second bundles having different diameters so that the wires in a bundle with a greater diameter have a greater diameter and the wires in the bundle with a smaller diameter have a smaller diameter, and the wires of all said bundles are twisted in opposite directions so that the wires in respective one of said first and second bundles having a greater diameter is twisted in one direction, while the wires in one of said bundles which adjoins the bundle with a greater diameter and has a smaller diameter is twisted in an opposite direction, wherein said bundles in said first plurality of bundles have the diameters increasing in a first direction, while said bundles in said second pluralty of diameters have the bundles increasing in the same first direction.

2. An electrical cable as defined in claim 1, wherein said bundles in said first plurality of bundles and in said second plurality of bundles have an increasing diameter in opposite directions.

3. (canceled)

4. An electrical cable as defined in claim 1, wherein the bundles of each of said first and second plurality of bundles include identical numbers of wires.

5. An electrical cable comprising a first plurality of bundles each including a plurality of wires and connectable to a positive pole of a current source at one end; a second plurality of bundles each including a plurality of wires and connectable with a negative pole of the current source at one end: said bundles of said first plurality include bundles of different diameters and arranged so that the diameters of the bundles increase in one after the other, while said second pluralty of bundles including bundles of different diameters and arranged so that the diameters of the bundles also increase one after the other said wires in each of said first and second bundles having different diameters so that the wires in a bundle with a creater diameter have a greater diameter and the wires in the bundle with a smaller diameter have a smaller diameter, and the wires of all said bundles are twisted in opposite directions so that the wires in respective one of said first and second bundles having a greater diameter is twisted in one direction, while the wires in one of said bundles which adjoins the bundle with a greater diameter and has a smaller diameter is twisted in an opposite direction; and further comprising a core located between said bundles of said first plurality of bundles and said bundles of said second plurality of bundles and substantially centrally of the cable.

6. An electrical cable as defined in claim 1, wherein each of said bundles have a sheath which covers it, said sheathes being composed of different materials.

7. An electrical cable as defined in claim 1, wherein the bundles of each of said first and second plurality of bundles include different numbers of wires.

8. An electrical cable as defined in claim 1, wherein said bundles are provided with sheaths that are composed of different materials.

9. An electrical cable as defined in claim 1, wherein said bundles are provided with sheaths that are composed of a material which is different from a material of a jacket surrounding all the bundles.

10. An electrical cable, comprising a first plurality of bundles each including a plurality of wires and connectable to a positive pole of a current source at one end; a second plurality of bundles each including a plurality of wires and connectable with a negative pole of the current source at one end; said bundles of said first plurality include bundles of different diameters and arranged so that the diameters of the bundles increase in one after the other, while said second plurality of bundles including bundles of different diameters and arranged so that the diameters of the bundles also increase one after the other, said wires in each of said first and second bundles having different diameters so that the wires in a bundle with a greater diameter have a greater diameter and the wires in the bundle with a smaller diameter have a smaller diameter, and the wires of all said bundles are twisted in opposite directions so that the wires in respective one of said first and second bundles having a greater diameter is twisted in one direction while the wires in one of said bundles which adjoins the bundle with a greater diameter and has a smaller diameter is twisted in an opposite direction; and further comprising a separating element located between the first and second bundles and composed of a material which is different from a material of sheaths of all said bundles.

11. An electrical cable as defined in claim 10, wherein said separating element is a part of a central core.
